(19) United States
(12) Patent Application Publication
(10) Pub. No.: US 2009/0217815 A1
(43) Pub. Date: Sep. 3, 2009

(54) Pneumatic or Hydraulic Cylinder

(76) Inventor: Jeffrey Kendall, Nairne (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/922,193

(22) PCT Filed: Jun. 2, 2006
(86) PCT No.: PCT/AU2006/000741

§ 371 Date: Feb. 12, 2009

(51) Int. Cl. F15B 15/06

(52) U.S. Cl. 92/31; 92/68

(57) ABSTRACT

A pneumatic or hydraulic cylinder (10) that has a piston (14) provided with a plurality of spherical elements (22), each of which is engaged in a slot (20) that extends longitudinally and axially relative to the longitudinal axis (12) of the cylinder (10). Movement of the piston (14) longitudinally results in angular movement of a piston (14) due to engagement of the elements (22) in their slots (20).

### TECHNICAL FIELD

The present invention relates to hydraulic and pneumatic cylinders and more particularly but not exclusively to hydraulic cylinders as described in International Patent Application PCT/AU2004/001677.

### BACKGROUND OF THE INVENTION

Hydraulic cylinders include a cylinder (barrel) with a bore that slidably receives a piston. The piston moves longitudinally of the bore. The cylinder of the abovementioned patent application has a mechanism that locks the piston with the piston rod in a retracted position.

The abovementioned hydraulic cylinder was initially designed for use in raising and lowering the load receiving tray of a vehicle. However it also found application in another arrangement, that is, a vehicle seat that is moved laterally out of a vehicle door for the purposes of making it easier for disabled passengers to use the vehicle. This arrangement is described in Australian Provisional Applications 2004905651 and 2004903272.

The abovementioned hydraulic and pneumatic cylinders have the disadvantage that they only provide for movement longitudinally of the longitudinal axis of the cylinder.

### OBJECT OF THE INVENTION

It is the object of the present invention to overcome or substantially ameliorate the above disadvantage.

### SUMMARY OF THE INVENTION

There is disclosed herein a pneumatic or hydraulic cylinder having a longitudinal axis to be activated by fluid under pressure, the cylinder including:
a barrel having a bore surrounding a longitudinally extending chamber;
a piston slidably located in the bore for longitudinal movement thereof, the piston cooperating with said bore to divide said chamber into a first sub-chamber and a second sub-chamber, the sub-chambers being separated by the piston, with the volume of the sub-chambers being varied by longitudinal movement of the piston, with hydraulic fluid under pressure being delivered to the sub-chambers to cause longitudinal movement of the piston;
a first surface, said surface extending longitudinally and angularly with respect to said longitudinal axis; and
a second surface, said second surface being engagable with said first surface, with the surfaces being operatively associated with said bore and piston so that longitudinal movement of said piston with respect to said bore causes relative movement between the surfaces which in turn causes angular movement of the piston relative to the bore about said axis.

Preferably, said first surface is provided by a groove extending longitudinally and angularly about said axis, and said second surface is provided by a spherical element at least partly projecting into said groove.

Preferably, said groove is in said piston and said spherical element is maintained substantially fixed in location with respect to said bore so that engagement of said spherical element in said groove causes said angular movement.

Preferably, said piston has a plurality of grooves, and said cylinder includes a plurality of spherical elements, the spherical elements being retained in recesses in said bore, with each groove being operatively associated with a respective one of the elements.

Preferably, the elements are angularly spaced about said axis at equally angular intervals.

Preferably, in said cylinder, said barrel is a first barrel, said bore is a first bore and said chamber is a first chamber, with said cylinder further including:
a second barrel, said second barrel having a second bore;
a piston rod, said piston rod being slidably located in said second bore and cooperating therewith to provide a variable volume second chamber into which fluid under pressure is delivered to move the piston rod to change the volume of said second chamber;
a port in communication with said second chamber and via which fluid is allowed to pass;
a lock assembly mounted on the piston rod, the assembly including:
at least one locking member movable relative to said axis between a radially inner position permitting movement of the piston rod, and a radially outer position engaging the second barrel to prevent movement of the piston rod in a predetermined direction beyond a predetermined longitudinal position;
a retaining member mounted on the piston rod and movable longitudinally relative thereto between a first position retaining a locking member in a radially outer position, and a second position providing for movement of the locking member to the radially inner position;
means to urge the retaining member to the first position thereof to thereby urge the locking member to the radially outer position; and
wherein said retaining member when in the first position and exposed to the fluid under pressure is moved to the second position thereof to allow movement of the locking member to the radially inner position to free set piston rod for movement in said direction.

Preferably, said cylinder includes a piston rod in a first piston rod and said assembly includes a second piston rod, the second piston rod being attached to said piston so as to move angularly therewith, and wherein said second piston rod extends into said first piston rod, with angular movement of said second piston rod about said axis causing angular movement of said first piston rod about said axis.

Preferably, said second piston rod is telescopically received within said first piston rod.

Preferably, said locking member is spherical in configuration.

Preferably, said locking member is a first locking member, and said cylinder includes further locking members, all the locking members being spherical in configuration with the same diameter, the locking members being angularly spaced about said axis.

Preferably, the means to urge is a spring extending between said retaining member and said second piston.

Preferably, said cylinder includes a third chamber which is sealingly separated from the second chamber.

Preferably, fluid under pressure delivered to the second chamber causes movement of the second piston rod in said predetermined direction while if delivered to said third chamber causes the piston rod to move in a direction opposite to said predetermined direction.

Preferably, said retaining member moves in said predetermined direction relative to said piston rod when moving from the first position to the second positions.

### BRIEF DESCRIPTION OF THE DRAWINGS

A preferred form of the present invention will now be described by way of example with reference to the accompanying drawings wherein:

FIG. 1 is a schematic sectioned side elevation of a hydraulic or pneumatic cylinder, the cylinder being in a first configuration;

FIG. 2 is a schematic sectioned side elevation of the cylinder of FIG. 1 in a second configuration;

FIG. 3 is a schematic sectioned side elevation of the cylinder of FIG. 1 in a third configuration;

FIG. 4 is a schematic sectioned end elevation of portion of the cylinder of FIG. 1; and

FIG. 5 is a schematic isometric view of a piston employed in the cylinder of FIG. 1.

### DETAILED DESCRIPTION OF THE PREFERRED EMBODIMENT

In the accompanying drawings there is schematically depicted a hydraulic or pneumatic cylinder 10. The cylinder 10 is operated by a liquid or a gas under pressure, such as air or hydraulic fluid. In the following example the cylinder 10 is operated by hydraulic fluid.

The cylinder 10 includes a barrel 11 having a longitudinal axis 12 and an internal bore 13. The bore 13 is of a cylindrical configuration and slidably receives a piston 14. The piston 14 sealingly engages the bore 13 by means of a seal 15.

The bore 13 surrounds a chamber 16 that is divided into a first sub-chamber 17 and a second sub-chamber 18 by means of a piston 14.

The piston 14 has longitudinally extending generally cylindrical side surface 19 that is provided with a plurality of grooves or slots 20, the slots 20 being arcuate in transverse cross-section. The slots 20 extend longitudinally and angularly about the longitudinal axis 12. That is the slots 20 extend in a spiral manner about the axis 12.

The barrel 11 is provided with a plurality of apertures 21, with a spherical element 22 located in each of the apertures 21. The elements 21 project into the slots 20.

Upon hydraulic pressure being delivered to the sub-chamber 18 through the port 23, the piston 14 is caused to move in the direction of the arrow 24. This longitudinal movement of the piston 14 also results in angular movement of the piston 14 about the axis 12 due to engagement of the elements 22 in the slots 20. The piston 14 is moved in the direction 24 until the sub-chamber 17 is at its minimum volume. When the piston 14 is moved in the opposite direction to the direction 24, that is, by the delivery of hydraulic fluid under pressure to the port 24, the piston 14 is moved longitudinally so that it moves angularly in the opposite direction.

Attached to the piston 14 is a piston rod 25. The piston rod 25 is fixed to the piston 14 by means of a cap 26. The cap 26 has a circular flange 27 fixed to the piston 14 and a cavity portion 28 that is longitudinally splined. The cavity portion 28 also has an annular recess 29.

The piston rod 25 is longitudinally splined so as to matingly engage with the internal splines of the cavity portion 28, with a clip 30 engaged within the annular recess 29 fixing the piston rod 25 within the piston 14. Accordingly the rod 25 is fixed to the piston 14.

When the piston 14 moves longitudinally and angularly, the piston rod 25 moves in unison therewith.

The cylinder 10 includes a second barrel 31. The second barrel 31 being fixed to the first barrel 11 so as to be coaxial with respect thereto.

The barrel 31 has a bore 32 that slidably and sealingly engages a piston rod 33. The piston rod 33 has a tubular portion 34 that telescopically receives the piston rod 25. An extremity of the piston rod 33 has a head 35 with a cap 36.

The bore 32 surrounds a chamber 37 that is divided into a first sub-chamber 38 and a second sub-chamber 39 by the head 35 sealingly engaging the bore 32.

The head 35 and cap 36 provide an annular recess 46 that receives a plurality of spherical elements 40. The elements 40 are maintained in spaced angular positions about the axis 24 by the cap 38 having projections that operate as a cage retaining the elements 40 spaced as mentioned.

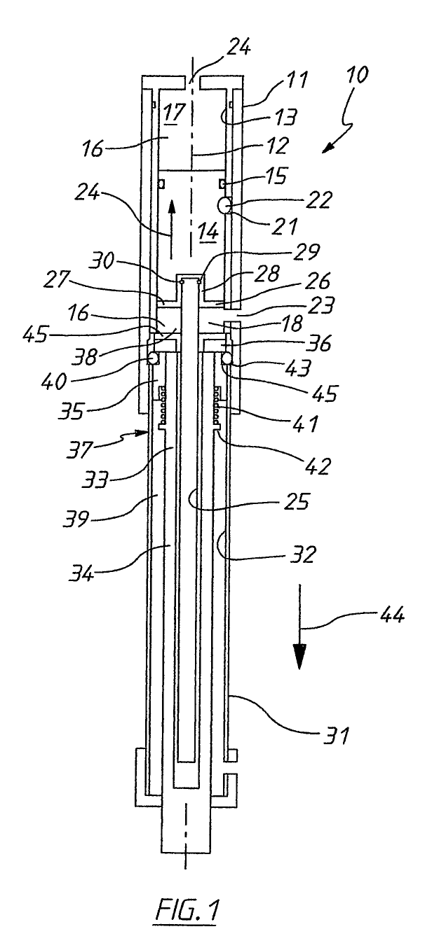

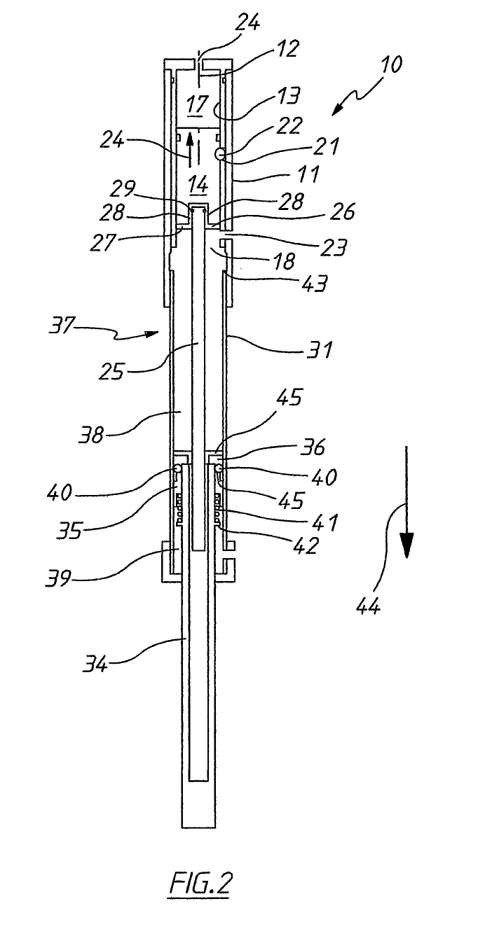

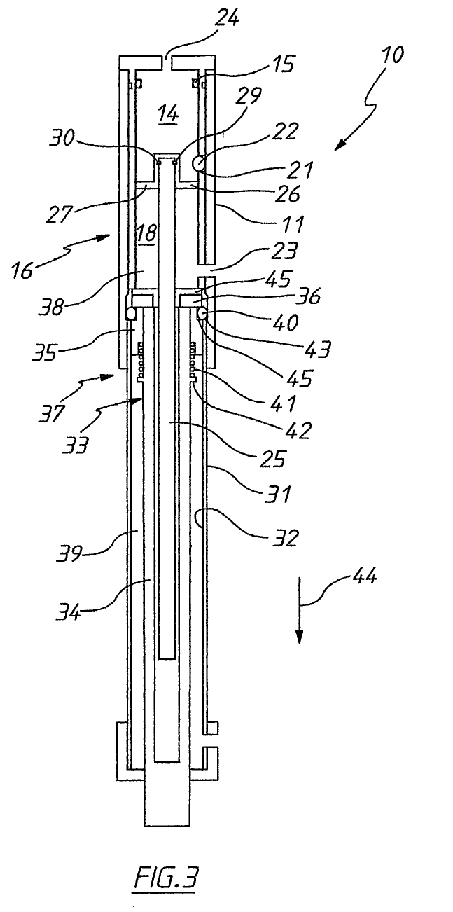

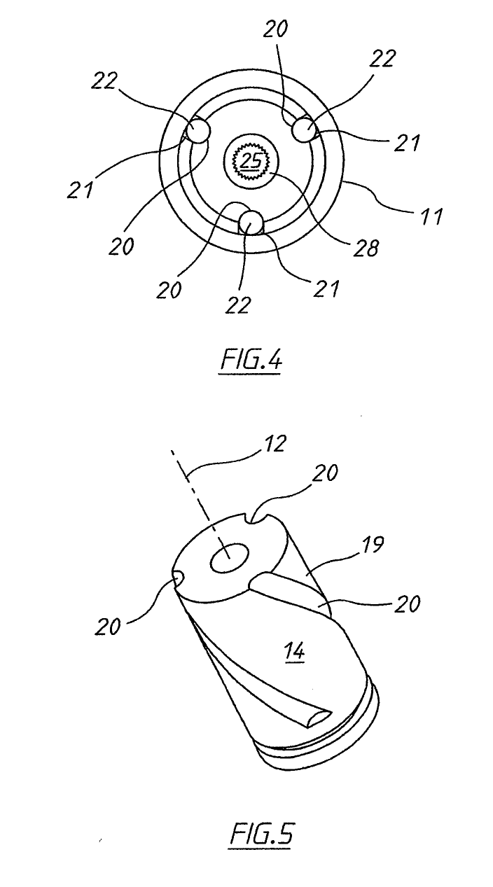

The head 35 is slidably mounted on the tubular portion 33 so as to be movable longitudinally of the axis 12 relative to the tubular portion 33 between the position shown in FIG. 1 and the position shown in FIG. 2. In the position shown in FIG. 1, the head 35 is located adjacent the port 23 while in the position shown in FIG. 2, the head 35 is displaced from the port 23.

The elements 40 are movable radially relative to the axis 24 so as to be movable between a radially outer position (FIG. 1) maintaining the piston rod 33 in the retracted position, and a radially inner position permitting movement of the piston rod 33 to the position shown in FIG. 2.

The head 35 is urged by a spring 41 toward the port 23. The spring 41 bears against an annular flange 42 fixed to the tubular portion 33.

The bore 31 provides an annular step 43 that is engaged by the elements 40 when adjacent the port 23.

In operation of the cylinder 10, when hydraulic fluid under pressure is delivered to the sub-chamber 18 via the port 23, the hydraulic fluid under pressure moves the head 35 away from the cap 36. This movement allows radially inward movement of the elements 40. The pressure applied to the head 35 causes movement of the head to move away from the port 23 thereby compressing the spring 41.

This movement of the head 35 provides for radially inward movement of the elements 40. Due to pressure applied to the head 35 and the piston rod 33, the piston rod 33 is urged to move in the direction of the arrow 44. By engagement with the cap 36, the elements 40 are moved radially inwardly thereby releasing the piston rod 33 for movement in the direction of the arrow 44. Accordingly the piston rod 33 moves to the position shown in FIG. 2.

Movement of the piston rod 33 relative to the piston 40 can be coordinated by preventing or permitting movement of hydraulic fluid through the port 24. For example, once the piston rod 33 has reached the limit of its travel, such as in FIG. 2, the port 24 can be opened. The hydraulic fluid delivered to the sub-chamber 18 will then cause movement of the piston 14 in the direction of the arrow 24.

Attached to the tubular portion 13 is a splined bearing 45 that slidably engages the piston rod 25 so that angular movement of the piston rod 25 also causes angular movement of the piston rod 33 about the axis 12.

1. A pneumatic or hydraulic cylinder having a longitudinal axis to be activated by fluid under pressure, the cylinder including: a barrel having a bore surrounding a longitudinally extending chamber; a piston slidably located in the bore for longitudinal movement thereof, the piston cooperating with said bore to divide said chamber into a first sub-chamber and a second sub-chamber, the sub-chambers being separated by the piston, with the volume of the sub-chambers being varied by longitudinal movement of the piston, with hydraulic fluid under pressure being delivered to the sub-chambers to cause longitudinal movement of the piston; a first surface, said surface extending longitudinally and angularly with respect to said longitudinal axis; and a second surface, said second surface being engagable with said first surface, with the surfaces being operatively associated with said bore and piston so that longitudinal movement of said piston with respect to said bore causes relative movement between the surfaces which in turn causes angular movement of the piston relative to the bore about said axis.

2. The cylinder of claim 1, wherein said first surface is provided by a groove extending longitudinally and angularly about said axis, and said second surface is provided by a spherical element at least partly projecting into said groove.

3. The cylinder of claim 2, wherein said groove is in said piston and said spherical element is maintained substantially fixed in location with respect to said bore so that engagement of said spherical element in said groove causes said angular movement.

4. The cylinder of claim 3, wherein said piston has a plurality of grooves, and said cylinder includes a plurality of spherical elements, the spherical elements being retained in recesses in said bore, with each groove being operatively associated with a respective one of the elements.

5. The cylinder of claim 4, wherein the elements are angularly spaced about said axis at equally angular intervals.

6. The cylinder of claim 1, wherein said cylinder, said barrel is a first barrel, said bore is a first bore and said chamber is a first chamber, with said cylinder further including:
a second barrel, said second barrel having a second bore;
a piston rod, said piston rod being slidably located in said second bore and cooperating therewith to provide a variable volume second chamber into which fluid under pressure is delivered to move the piston rod to change the volume of said second chamber;
a port in communication with said second chamber and via which fluid is allowed to pass;
a lock assembly mounted on the piston rod, the assembly including:
at least one locking member movable relative to said axis between a radially inner position permitting movement of the piston rod, and a radially outer position engaging the second barrel to prevent movement of the piston rod in a predetermined direction beyond a predetermined longitudinal position;
a retaining member mounted on the piston rod and movable longitudinally relative thereto between a first position retaining a locking member in a radially outer position, and a second position providing for movement of the locking member to the radially inner position;
means to urge the retaining member to the first position thereof to thereby urge the locking member to the radially outer position; and
wherein said retaining member when in the first position and exposed to the fluid under pressure is moved to the second position thereof to allow movement of the locking member to the radially inner position to free set piston rod for movement in said direction.

7. The cylinder of claim 6, wherein said piston rod in a first piston rod and said assembly includes a second piston rod, the second piston rod being attached to said piston so as to move angularly therewith, and wherein said second piston rod extends into said first piston rod, with angular movement of said second piston rod about said axis causing angular movement of said first piston rod about said axis.

8. The cylinder of claim 7, wherein said second piston rod is telescopically received within said first piston rod.

9. The cylinder of claim 6, wherein said locking member is spherical in configuration.

10. The cylinder of claim 9, wherein said locking member is a first locking member, and said cylinder includes further locking members, all the locking members being spherical in configuration with the same diameter, the locking members being angularly spaced about said axis.

11. The cylinder of claim 6, wherein the means to urge is a spring extending between said retaining member and said second piston.

12. The cylinder of claim 6, wherein said cylinder includes a third chamber which is sealingly separated from the second chamber.

13. The cylinder of claim 12, wherein fluid under pressure delivered to the second chamber causes movement of the second piston rod in said predetermined direction while if delivered to said third chamber causes the piston rod to move in a direction opposite to said predetermined direction.

14. The cylinder of claim 6, wherein said retaining member moves in said predetermined direction relative to said piston rod when moving from the first position to the second positions.
